(19) United States
(12) Patent Application Publication
(10) Pub. No.: US 2020/0213494 A1
(43) Pub. Date: Jul. 2, 2020

(54) METHOD FOR PROCESSING IMAGE ON BASIS OF EXTERNAL LIGHT, AND ELECTRONIC DEVICE SUPPORTING SAME

(71) Applicant: Samsung Electronics Co., Ltd., Gyeonggi-do (KR)

(72) Inventor: Kyong Tae PARK, Gyeonggi-do (KR)

(21) Appl. No.: 16/634,761

(22) PCT Filed: Apr. 17, 2018
(86) PCT No.: PCT/KR2018/004414

§ 371 Date: Jan. 28, 2020

(30) Foreign Application Priority Data
Aug. 21, 2017 (KR) 10-2017-0105709

(51) Int. Cl. H04N 5/225; H04N 9/07; H04N 9/73

(52) U.S. Cl. CPC H04N 5/2258; H04N 5/2256; H04N 9/735; H04N 9/07

(57) ABSTRACT

Disclosed is an electronic device that may include a first optical sensor that has a response characteristic to a first wavelength band, a second optical sensor that has a response characteristic to a second wavelength band different from the first wavelength band, at least one camera module, and a processor electrically connected to the first and second optical sensors and the camera module. The processor may obtain an image corresponding to an external object by using the camera module, obtain a first signal corresponding to the first wavelength band by using the first optical sensor, obtain a second signal corresponding to the second wavelength band by using the second optical sensor, select at least one piece of optical information from specified optical information based on the first and second signals, and adjust a white balance of the image based on the selected at least one piece of optical information. Above this, various embodiments figured out through the specification are possible.

### TECHNICAL FIELD

Various embodiments disclosed in the disclosure relate to an electronic device that processes an image based on external light.

### BACKGROUND ART

The image capturing apparatus may implement color differences by reflecting color temperature characteristics of a light source in an operating environment. In this regard, a subject may generate reflected light corresponding to the color temperature of an ambient light source. For example, a white color subject may generate red reflected light for a light source having a low color temperature, and blue reflected light for a light source having a high color temperature. An image photographing device may receive and reproduce the reflected light of a subject as described above, thereby expressing a color tone of the subject.

### DISCLOSURE

### Technical Problem

In order to compensate for color difference of a subject caused by different color temperatures of various light sources, a recent image photographing device has a white balance function. However, the conventional white balance function may be inferior in reliability of determining the attribute (e.g., type) of an ambient light source, or may be cumbersome for allowing the user to directly set the attribute of the ambient light source when operating the image photographing device.

Various embodiments disclosed in the disclosure provide a method of processing an image based on external light, which is capable of adjusting white balance with high reliability by determining an attribute of an ambient light source and identifying a corresponding color temperature, and an electronic device supporting the same.

### Technical Solution

According to an embodiment, an electronic device may include a first optical sensor that has a response characteristic to a first wavelength band, a second optical sensor that has a response characteristic to a second wavelength band different from the first wavelength band, at least one camera module, and a processor electrically connected to the first and second optical sensors and the camera module.

According to an embodiment, the processor may obtain an image corresponding to an external object by using the camera module, obtain a first signal corresponding to the first wavelength band by using the first optical sensor, obtain a second signal corresponding to the second wavelength band by using the second optical sensor, select at least one piece of optical information from specified optical information based on the first and second signals, and adjust a white balance of the image based on the selected at least one piece of optical information.

According to an embodiment, an electronic device may include at least one camera module including an image sensor, and a processor electrically connected to the camera module.

According to an embodiment, the processor may obtain an image corresponding to an external object by using the camera module, obtain a first signal corresponding to a first wavelength band and a second signal corresponding to a second wavelength band different from the first wavelength band by using image sensor, select at least one piece of optical information from specified optical information based on the first and second signals, and adjust a white balance of the image based on the selected at least one piece of optical information.

According to various embodiments, a method of processing an image based on external light in an electronic device may include obtaining the image corresponding to an external object, obtaining a first signal corresponding to a first wavelength band, obtaining a second signal corresponding to a second wavelength band different from the first wavelength band, selecting at least one piece of optical information from specified optical information based on the first and second signals, and adjusting a white balance of the image based on the selected at least one piece of optical information.

### Advantageous Effects

According to various embodiments, an environment in which an electronic device is operated may be identified based on an attribute determination of an ambient light source.

According to various embodiments, in performing image processing, color tone improvement for an output image may be implemented by variably adjusting a white balance corresponding to an operating environment of an identified electronic device.

In addition, various effects directly or indirectly ascertained through the present disclosure may be provided.

### DESCRIPTION OF DRAWINGS

FIG. 1A is a graph illustrating various SPDs of light detected in a first operating environment of an electronic device according to an embodiment.

FIG. 1B is a graph illustrating various SPDs of light detected in a second operating environment of an electronic device according to an embodiment

FIG. 1C is a graph illustrating various SPDs of light detected in a third operating environment of an electronic device according to an embodiment.

FIG. 2 is a view illustrating a configuration of an electronic device according to an embodiment.

FIG. 3 is a graph illustrating a form of a database constructed in an electronic device according to an embodiment.

FIG. 4 is a graph illustrating a correlation between a ratio of a light component in a first wavelength band and a light component in a second wavelength band and a color temperature value according to an embodiment.

FIG. 5 is a flowchart illustrating an image processing method of an electronic device according to an embodiment.

FIG. 6 is a view illustrating an electronic device for supporting image processing based on an external light in a network environment according to an embodiment.

With regard to the description of the drawings, identical or similar reference numerals may be used to refer to identical or similar components.

### MODE FOR INVENTION

Hereinafter, various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar components may be marked by similar reference numerals.

In the present disclosure, the expressions “have”, “may have”, “include” and “comprise”, or “may include” and “may comprise” used herein indicate existence of corresponding features (e.g., components such as numeric values, functions, operations, or parts) but do not exclude presence of additional features.

In the present disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in the present disclosure may be used to refer to various components regardless of the order and/or the priority and to distinguish the relevant components from other components, but do not limit the components. For example, “a first user device” and “a second user device” indicate different user devices regardless of the order or priority. For example, without departing the scope of the present disclosure, a first component may be referred to as a second component, and similarly, a second component may be referred to as a first component.

It will be understood that when a component (e.g., a first component) is referred to as being “(operatively or communicatively) coupled with/to” or “connected to” another component (e.g., a second component), it may be directly coupled with/to or connected to the other component or an intervening component (e.g., a third component) may be present. In contrast, when a component (e.g., a first component) is referred to as being “directly coupled with/to” or “directly connected to” another component (e.g., a second component), it should be understood that there are no intervening components (e.g., a third component).

According to the situation, the expression “configured to” used in the present disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in the present disclosure are used to describe specified embodiments and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of the present disclosure. In some cases, even if terms are terms which are defined in the present disclosure, they may not be interpreted to exclude embodiments of the present disclosure.

An electronic device according to various embodiments of the present disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs)), a fabric or garment-integrated type (e.g., an electronic apparel), a body-attached type (e.g., a skin pad or tattoos), or a bio-implantable type (e.g., an implantable circuit).

According to various embodiments, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, and the like.

According to another embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automated teller machines (ATMs), points of sales (POSs) of stores, or internet of things (e.g., light bulbs, various sensors, electric or gas meters, sprinkler devices, fire alarms, thermostats, street lamps, toasters, exercise equipment, hot water tanks, heaters, boilers, and the like).

According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be one of the above-described devices or a combination thereof. An electronic device according to an embodiment may be a flexible electronic device. Furthermore, an electronic device according to an embodiment of the present disclosure may not be limited to the above-described electronic devices and may include other electronic devices and new electronic devices according to the development of technologies.

Hereinafter, electronic devices according to various embodiments will be described with reference to the accompanying drawings. In the present disclosure, the term “user” may refer to a person who uses an electronic device or may refer to a device (e.g., an artificial intelligence electronic device) that uses the electronic device.

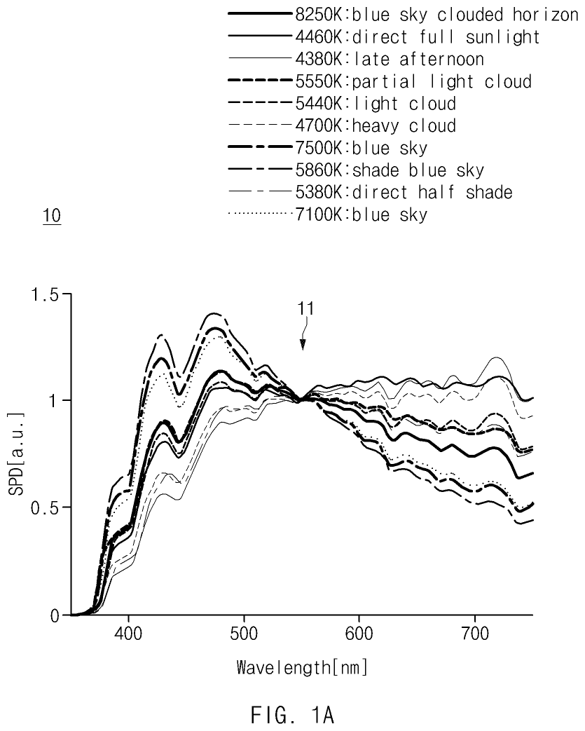

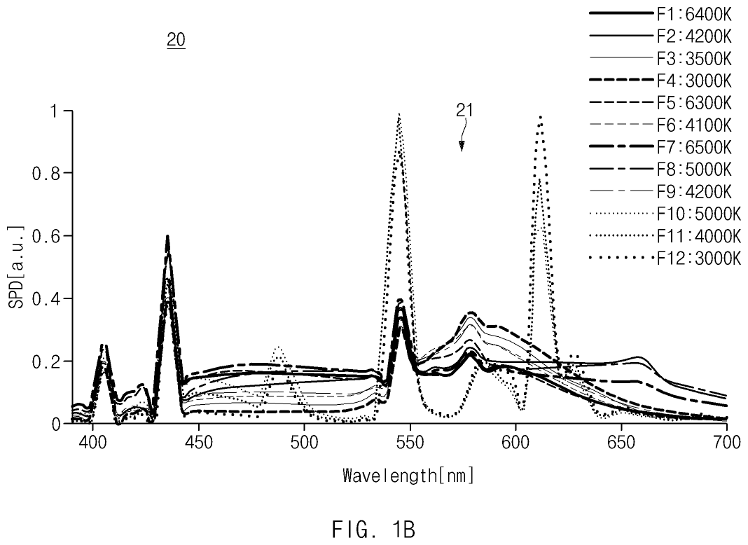

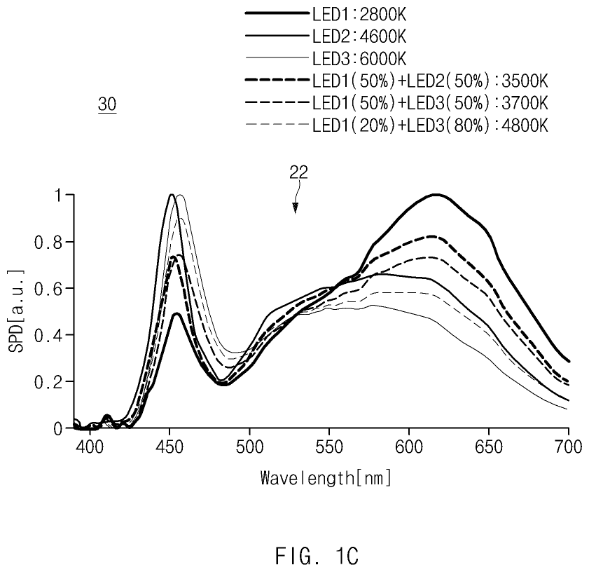

In advance of describing the disclosure, spectral power distribution (SPD) characteristics that may be referred to various embodiments of the disclosure will be described with reference to FIGS. 1A, 1B and 1C.

FIGS. 1A to 1C are graphs illustrating various SPDs of light detected in various operating environments of an electronic device according to an embodiment.

In an embodiment, an electronic device may be equipped with at least one optical sensor to detect at least a portion of the light emitted from a light source in an operating environment. In this regard, referring to FIG. 1A, the electronic device may detect light of a first light source (e.g., the sun) in a first operating environment 10 corresponding to an outdoor environment and may output a spectral power distribution (SPD) 11 for the detected light. At least one SPD 11 illustrated in FIG. 1A may be understood as an aspect of superimposing various SPDs for the light of the first light source detected under various conditions (e.g., daily time, standby state, and the like) of the first operating environment 10.

In an embodiment, the first light source (e.g., the sun) may emit lights having different color temperatures under various conditions (e.g., daily time, standby state, and the like) of the first operating environment 10. At least one light corresponding to each condition may be output in the SPD 11 having a similar form over the entire wavelength band. For example, the at least one light may be output in the SPD 11 representing a distribution form of black body radiation based on the radiation principle of the first light source (e.g., the sun). However, the SPD 11 for at least one light under various conditions of the first operating environment 10 may be at least partially different in the distribution form of the black body radiation according to the color temperature corresponding to each light. For example, the light distribution ratio of the light having a higher color temperature among the at least one light may increase in the short wavelength band (e.g., the ultraviolet wavelength band or 400 nm adjacent band), and the light distribution ratio may decrease in the long wavelength band (e.g., the infrared wavelength band or 700 nm adjacent band). Correspondingly, the light distribution ratio of the light having a lower color temperature may decrease in the short wavelength band and increase in the long wavelength band. Based on the above description, the light of the first light source (e.g., the sun) corresponding to the first operating environment 10 may be output in a standardized form of SPD (e.g., based on the distribution form of the black body radiation, the form having the opposite light distribution ratio in the short wavelength and long wavelength bands).

Referring to FIGS. 1B and 1C in connection with the above description, in the second or third operating environment 20 or 30 corresponding to a room, the SPD 21 output by detecting the light corresponding to the second light source (e.g., a fluorescent lamp) having various attributes (e.g., a manufacturer, a product model, and the like), or the SPD 22 output corresponding to the third light source (e.g., an LED) having various attributes may not include the SPD characteristics of the above-described first light source (e.g., the sun). For example, the color temperature of the second light source (e.g., a fluorescent light) may be variably adjusted corresponding to the size or arrangement location of the light source. In the case of the third light source (e.g., an LED), the color temperature may be adjusted corresponding to an excitation wavelength. Accordingly, the SPD characteristics (e.g., distribution characteristics of black body radiation or light distribution characteristics opposite to each other in the short wavelength and long wavelength bands depending on the color temperature) of the first light source (e.g., the sun) may not be expressed in the SPDs 21 of the second light source (e.g., a fluorescent lamp) or the SPDs 22 of the third light source (e.g., an LED).

Based on the above description, the electronic device according to an embodiment may analyze the SPD of light detected in an arbitrary operating environment to identify the attribute (e.g., the type of the light source) of the light source which emits the light, and may determine the operating environment (e.g., outdoor or indoor) based on the identified attribute of the light source. For example, when the SPD output in an arbitrary operating environment includes the same or similar characteristics as the SPD characteristics of the first light source (e.g., the sun), the electronic device may identify the light source related to the SPD as the first light source (e.g., the sun). Furthermore, the electronic device may determine that the electronic device is operating in the outdoor environment based on the identification of the first light source (e.g., the sun).

According to an embodiment, the electronic device may determine a color temperature corresponding to an attribute of a light source (e.g., a type of light source) or an operating environment, and refer to the determined color temperature to perform a function of a specific component. For example, the electronic device may adjust a white balance based on the determined color temperature in relation to image processing of an image (e.g., a still image or a moving image) obtained by photographing an arbitrary subject. Hereinafter, various embodiments of adjusting a white balance of a photographed image based on the identification of an attribute (e.g., a type of a light source) of a light source or the operating environment determination of the electronic device and the functional operations of an electronic device implementing the same will be described with reference to the accompanying drawings.

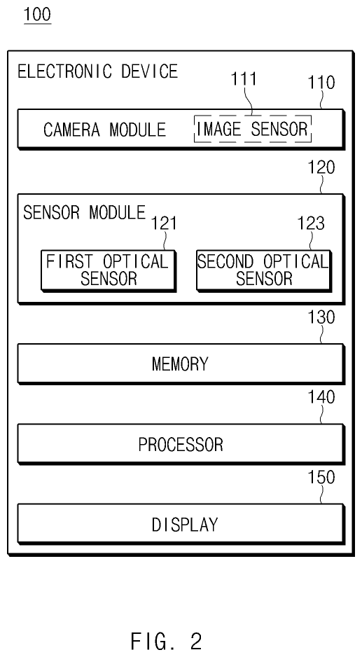

FIG. 2 is a view illustrating a configuration of an electronic device according to an embodiment.

Referring to FIG. 2, an electronic device 100 may include a camera module 110, a sensor module 120, a memory 130, a processor 140, or a display 150. According to various embodiments, at least one of the above-described components may be omitted from the electronic device 100 or the electronic device 100 may additionally include other components. For example, the electronic device 100 may further include a housing (not shown) or a communication circuit (or a communication interface or a communication module: not shown). The housing may constitute at least a part of an appearance of the electronic device 100, and components of the electronic device 100 may be arranged in the housing or on the housing. The communication circuit may support communication between the electronic device 100 and at least one external device. For example, the communication circuit may establish wired or wireless communication in accordance with a specified protocol with an external device, and may interact with the external device based on the wired or wireless communication to transmit or receive various data (e.g., image data obtained through the camera module 110), a signal, or an information resource.

The camera module 110 may be implemented as at least one to capture an image (e.g., still image or video) of a peripheral area of the electronic device 100. In this regard, each of the at least one camera module 110 may be arranged in the electronic device 100 to have different angles of view (or at least partially overlapped). Alternatively, the at least one camera module 110 may be arranged at locations opposite to each other on the electronic device 100 to photograph the front and rear regions of the electronic device 100. In various embodiments, the camera module 110 may be fixed at the arranged location, or at least a portion thereof may move in response to user control at the arranged location. According to various embodiments, when a plurality of camera modules 110 is provided, the electronic device 100 may include an image editing program. The processor 140 may edit (e.g., stitching) the plurality of images photographed by the plurality of camera modules 110 based on the image editing program.

The sensor module 120 may detect at least a portion of light emitted from an operating environment (or a peripheral area) of the electronic device 100. In this regard, the sensor module 120 may include a first optical sensor 121 and a second optical sensor 123 having response characteristics with respect to specific wavelength bands. As at least a part of the response characteristic, for example, the first optical sensor 121 may detect light in a first wavelength band (e.g., an ultraviolet wavelength band) to output an electrical signal, and the second optical sensor 123 may detect light in a second wavelength band (e.g., an infrared wavelength band) different from the first wavelength band to output an electrical signal. In an embodiment, at least one of the first and second optical sensors 121 and 123 may include at least one photodiode, and may detect light based on the photovoltaic effect of the pn junction. Alternatively, at least one of the first optical sensor 121 and the second optical sensor 123 may detect light of a corresponding wavelength band based on a band-pass filter. According to various embodiments, the sensor module 120 may further include an illuminance sensor (not shown). The illuminance sensor may sense the brightness of the peripheral area of the electronic device 100 in real time or at a scheduled period and transmit the information (e.g., an illuminance value) to the processor 140.

In various embodiments, the first and second optical sensors 121 and 123 may be excluded from the electronic device 100. The electronic device 100 may detect lights in the first and second wavelength bands based on the functional operation of an image sensor 111 included in the camera module 110 described above. In this regard, some of the at least one pixel included in the image sensor 111 may include a first pattern (e.g., an R, UV, G and B pattern) that is implemented in combination of at least one color filter (e.g., a red filter, a green filter, or a blue filter) and a first wavelength band filter (e.g., a UV filter), and some other may include a second pattern (e.g., an R, IR, G and B pattern) that is implemented in combination of the at least one color filter and a second wavelength band filter (e.g., an IR filter). The image sensor 111 may detect lights in the first and second wavelength bands based on the first and second patterns, output electrical signals corresponding to the lights, and transmit the electronic signals to the processor 140. In various embodiments described below, although the electrical signal outputs for the first wavelength band and the second wavelength band according to the functional operation of the sensor module 120 are described as examples, the electrical signal output based on the image sensor 111 may be applied equally and similarly.

The memory 130 may store at least one data or information resource related to the components of the electronic device 100, or may store an command related to the functional operation of the electronic device 100. For example, the memory 130 may store an image photographed by the camera module 110. Alternatively, the memory 130 may store data related to at least one electrical signal output from the sensor module 120. For example, the memory 130 may store various SPD data on the light of the first light source (e.g., the sun) that is output under various conditions (e.g., daily time or standby state) of the first operating environment (e.g., an outdoor environment) described above with reference to FIG. 1A. In this regard, the memory 130 may store a database (or index) which is constructed while a specified condition of the first operating environment is matched with at least a portion (e.g., the SPD data in the ultraviolet wavelength band and the infrared wavelength band) of the SPD data on the light of the first light source output under the specific condition by the processor 140.

The processor 140 may be electrically or functionally connected to at least one component of the above-described electronic device 100 to perform control, communication operation, or data processing for the component. For example, the processor 140 may perform image processing (e.g., white balance) for an image captured by the camera module 110. In this operation, the processor 140 may analyze the electrical signal output from each of the first and second optical sensors 121 and 123 at the same time point as the image photographing or within a specified time range from the time point of photographing, thereby identifying the attribute of the light source (e.g., a type of light source) related to the image photographing. For example, when each electronic signal output from the first and second optical sensors 121 and 123 corresponds to the SPD data (e.g., the SPD data in the ultraviolet wavelength band and the infrared wavelength band) under the specific condition included in the database at a specified ratio or more, the processor 140 may identify the light source related to the image photographing as the first light source (e.g., the sun) and determine the operating environment of the electronic device 100 as an outdoor environment under the specified condition.

Alternatively, the processor 140 may identify the attribute of the light source based on the operating environment condition (e.g., an operating time or an ambient standby state) of the electronic device 100 corresponding to the same time point as the image photographing or within the specified time range from the time of photographing. In this regard, the processor 140 may identify the SPD data mapped with the condition identical or similar to the operating environment condition of the electronic device 100 in the database, and compare the electrical signals of the first and second optical sensors 121 and 123 output under the operating environment condition of the electronic device 100 with the identified SPD data. When the electrical signals are within a threshold range set based on the identified SPD data, the processor 140 may identify the light source related to the image photographing as the first light source (e.g., the sun). In various embodiments, the threshold range may be set by adding or subtracting specified data based on the identified SPD data.

In an embodiment, the processor 140 may calculate the color temperature value correspond to the operating environment of the identified light source or determined electronic device 100 by applying each electrical signal (or a signal value corresponding to the electrical signal, or the light quantity value corresponding to the electrical signal) output from the first and second optical sensors 121 and 123 into a specified equation. The processor 140 may generate the corrected image data by applying the calculated color temperature value to the image processing of the image captured at the same or similar time point as the electrical signal outputs of the first and second optical sensors 121 and 123.

According to various embodiments, the processor 140 may select the SPD data (e.g., SPD data corresponding to the electrical signals output from the first and second optical sensors 121 and 123) among various SPD data on the first light source (e.g., the sun) stored in the memory 130, which are referenced to determine the operating environment of the electronic device 100 or identify the attribute of the ambient light source. The processor 140 may map the color temperature value calculated based on the electrical signals corresponding to the selected SPD data and the selected SPD data, and store the mapped information in the memory 130. The processor 140 may refer to the mapping information stored in the memory 130 in relation to deriving the color temperature value corresponding to the operating environment of the electronic device 100 later.

The display 150 may output various contents. For example, the display 150 outputs the image photographed by the camera module 110 in the form of a preview, and convert the photographed image of the preview form into an image-processed image (or a white balance is performed based on the color temperature value corresponding to the ambient light source or the operating environment of the electronic device 100) in response to the control of the processor 140 according to the specified scheduling information (e.g., the specified time elapsed). Alternatively, the display 150 may output an interface for controlling image processing (or a white balance) of the captured image, and output an image corrected corresponding to a user input applied to the interface. Alternatively, the display 150 may simultaneously output the image captured by the camera module 110 and an image obtained by image-processing (or white balance adjusted) the captured image to the plurality of divided screen areas.

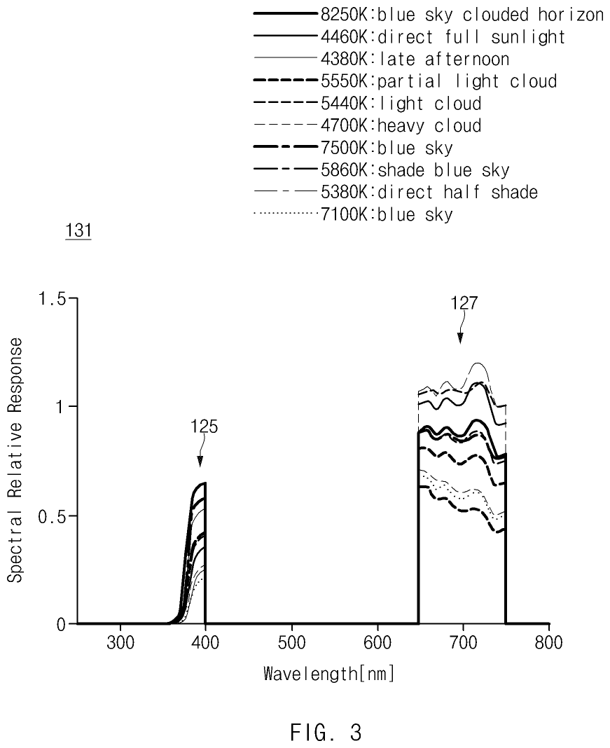

FIG. 3 is a graph illustrating a form of a database constructed in an electronic device according to an embodiment.

In an embodiment, each of the above-described first and second optical sensors (121 and 123 of FIG. 2) may detect a light in a related wavelength band and output it as an electrical signal. In this regard, when the electrical signal output from each of the first and second optical sensors 121 and 123 corresponds to one of at least one SPD data for the first wavelength band 125 (e.g., an ultraviolet wavelength band) and the second wavelength band 127 (e.g., an infrared wavelength band) constructed as a database 131 in a memory (130 of FIG. 2), the processor (140 of FIG. 2) of the electronic device (100 of FIG. 2) may identify the ambient light source of the electronic device 100 as the first light source (e.g., the sun). For example, when each electrical signal output from the first and second optical sensors 121 and 123 is similar to the SPD data under a specified condition among the SPD data at a specified ratio or more, the processor 140 may identify the ambient light source of the electronic device 100 as the first light source (e.g., the sun).

As another example of identifying the ambient light source, the processor 140 may identify the SPD data mapped to a condition identical or similar to an operating environment condition (e.g., a standby state) of the electronic device 100 on the database 131, and may compare the electrical signals of the first and second optical sensors 121 and 123 output under the operating environment condition of the electronic device 100 with the identified SPD data. According to an embodiment, when the electrical signals are included in a threshold range set based on the identified SPD data, the ambient light source of the electronic device 100 may be identified as the first light source (e.g., the sun).

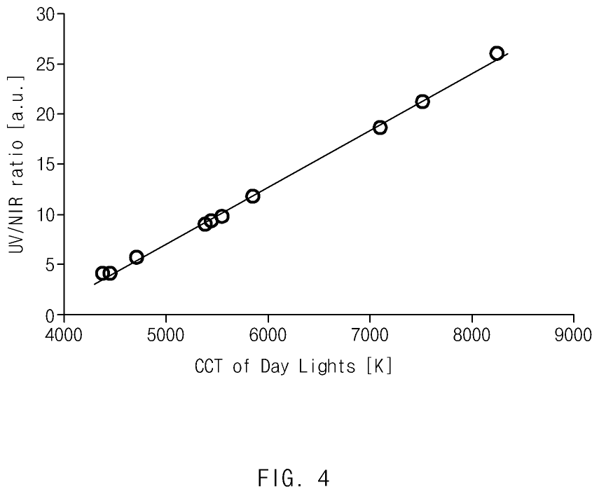

FIG. 4 is a graph illustrating a correlation between a ratio of a light component in a first wavelength band and a light component in a second wavelength band and a color temperature value according to an embodiment.

In an embodiment, the processor (140 of FIG. 2) of the electronic device (100 of FIG. 2) may calculate the color temperature value corresponding to the operating environment of the optical sensors 121 and 123, based on the ratio between the first light amount in the first wavelength band (e.g., the ultraviolet wavelength band) and the second light amount in the second wavelength band (e.g., the infrared wavelength band) (or the first and second electrical signal values corresponding to the first and second wavelength bands), which are detected by the first and second optical sensors (121 and 123 of FIG. 2).

$$CCT = A \frac{\sum UV ( λ )}{\sum NIR ( λ )} , where A \text{:} contant scaling factor . \qquad [ Equation 1 ]$$

Equation 1 may represent an exemplary form of calculating a color temperature value corresponding to the first light amount and the second light amount. As expressed as Equation 1, the processor 140 may calculate a correlated color temperature value corresponding to an environment (or an operating environment of the electronic device 100 or the optical sensors 121 and 123) in which the light amounts are detected based on the ratio between the sum of the first light amount in the first wavelength band and the sum of the second light amount in the second wavelength band.

Referring to FIG. 4 in relation to the above description, the ratio between the light amount of the first wavelength band (e.g., the ultraviolet wavelength band) and the light amount of the second wavelength band (e.g., the infrared wavelength band) may be linearly correlated with the calculated color temperature value. In other words, the color temperature value calculated from Equation 1 may increase proportionally as the light amount of the first wavelength band is larger than the light amount of the second wavelength band. As described above with reference to FIG. 1A, the light distribution ratio (or light amount) in a short wavelength band (e.g., the ultraviolet wavelength band or the first wavelength band) may correspond to the characteristic of the first light source (e.g., the sun) having a high color temperature value as the light distribution ratio of the short wavelength band increases. The processor 140 may apply the color temperature value calculated based on Equation 1 to image processing (e.g., white balance) of an image photographed by the camera module (110 of FIG. 2).

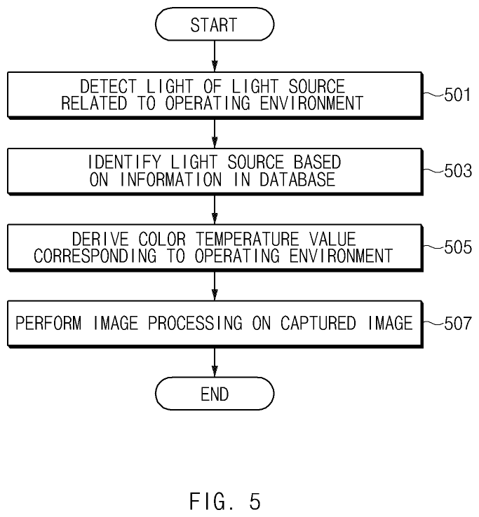

FIG. 5 is a flowchart illustrating an image processing method of an electronic device according to an embodiment.

In operation 501, the sensor module (120 of FIG. 2) of the electronic device (100 of FIG. 2) may detect light of a light source related to an operating environment of the electronic device 100 at the same time as a functional operation (e.g., photographing an arbitrary subject) of the camera module (110 of FIG. 2) or a time point within a specified time range from the functional operation. For example, the sensor module 120 may detect the light of the wavelength band corresponding to each of the optical sensors 121 and 123 based on the first and second optical sensors (121 and 123 of FIG. 2) included as components of the sensor module 120, and output an electronic signal. According to an embodiment, the first optical sensor 121 may detect the light of the first wavelength band (e.g., the ultraviolet wavelength band), and the second optical sensor 123 may detect the light of the second wavelength band different from the first wavelength band (e.g., the infrared wavelength band).

In operation 503, the processor (140 of FIG. 2) of the electronic device 100 may identify the light source related to the operating environment of the electronic device 100 based on the electrical signals output based on the light detections of the first and second optical sensors 121 and 123. For example, the processor 140 may identify the attribute (e.g., the kind of light source) of the light source by analyzing the electrical signal output with reference to the database (131 of FIG. 3) constructed in the memory (130 of FIG. 2). In this regard, the database 131 according to an embodiment may be constructed, in which various conditions (e.g., daily time, a standby state, and the like) for the first operating environment (e.g., an outdoor environment) are mapped to at least a portion (e.g., the SPD data of the ultraviolet wavelength band and the infrared wavelength band) of the SPD data for the first light source (e.g., the sun) corresponding to each of the various conditions.

In an embodiment, when each electrical signal output from the first and second optical sensors 121 and 123 corresponds to the SPD data under a specified condition included in the database 131 at a specified ratio or more, the processor 140 may determine the operating environment of the electronic device 100 as the first operating environment (e.g., an outdoor environment), and identify the ambient light source of the electronic device 100 as the first light source (e.g., the sun) based on the determined operating environment.

In another embodiment, the processor 140 may identify the ambient light source of the electronic device 100 based on the corresponding operating environment condition (e.g., an operating time, a standby state, and the like) of the electronic device 100 at the same time point as the functional operation of the camera module 110 or within a specified time range from the functional operation. For example, the processor 140 may identify the SPD data mapped to a condition identical or similar to the operating environment condition of the electronic device 100 in the database 131, and when the electrical signals output under the operating environment condition of the electronic device 100 are included within a threshold range set based on the identified SPD data, the processor 140 may identify the ambient light source of the electronic device 100 as the first light source (e.g., the sun).

In various embodiments, when the electrical signals output from each of the first and second optical sensors 121 and 123 do not correspond to the SPD data (or the SPD data mapped to a condition identical or similar to the operating environment condition of the electronic device 100) under various conditions of the database, the processor 140 may determine the operating environment of the electronic device 100 as the second operating environment (e.g., an indoor environment), and identify the ambient light source as the second light source (e.g., a fluorescent light, an LED, or the like).

In operation 505, the processor 140 may calculate the correlation color temperature value corresponding to the environment (or the operating environment of the electronic device 100 or the optical sensors 121 and 123) based on the ratio between the light amount of the first wavelength band (e.g., the ultraviolet wavelength band) detected by the first optical sensor 121 and the light amount of the second wavelength band (e.g., the infrared wavelength band) detected by the second optical sensor 123.

In operation 507, the processor 140 may perform image processing (e.g., the white balance) for an image captured by the camera module 110. In this operation, the processor 140 may apply the derived color temperature value to the image processing to correct at least a portion of the image captured by the camera module 110.

According to various embodiments, an electronic device may include a first optical sensor that has a response characteristic to a first wavelength band, a second optical sensor that has a response characteristic to a second wavelength band different from the first wavelength band, at least one camera module, and a processor electrically connected to the first and second optical sensors and the camera module.

According to various embodiments, the processor may obtain a first signal corresponding to the first wavelength band by using the first optical sensor, obtain a second signal corresponding to the second wavelength band by using the second optical sensor, determine an ambient light source of the electronic device based on the first and second signals, calculate a color temperature value corresponding to the ambient light source determined based on the first and second signals, and adjust a white balance of the image based on the calculated color temperature value.

According to various embodiments, the processor may obtain an image corresponding to an external object by using the camera module, obtain a first signal corresponding to the first wavelength band by using the first optical sensor, obtain a second signal corresponding to the second wavelength band by using the second optical sensor, select at least one piece of optical information from specified optical information based on the first and second signals, and adjust a white balance of the image based on the selected at least one piece of optical information.

According to various embodiments, the first optical sensor may respond to an ultraviolet wavelength band as at least a portion of the first wavelength band.

According to various embodiments, the second optical sensor may respond to an infrared wavelength band as at least a portion of the second wavelength band.

According to various embodiments, the electronic device may further include a memory that stores sunlight information of the first wavelength band and the second wavelength band corresponding to each of at least one condition associated with a first environment, as the at least a piece of the specified optical information.

According to various embodiments, the processor may select first sunlight information when the first and second signals correspond to the first sunlight information of the first and second wavelength bands corresponding to a first condition stored in the memory at a specified ratio or more.

According to various embodiments, the processor may determine an operating environment of the electronic device as the first environment based on the selected first sunlight information and determine an ambient light source of the electronic device as sunlight.

According to various embodiments, the processor may calculate a color temperature value corresponding to the selected at least one piece of optical information based on a ratio between a first value corresponding to the first signal and a second value corresponding to the second signal.

According to various embodiments, the processor may use the calculated color temperature value to adjust the white balance of the image.

According to various embodiments, the processor may store the calculated color temperature value and the selected at least one piece of optical information in the memory while mapping the calculated color temperature value and the selected at least one piece of optical information.

According to various embodiments, the electronic device may further include a display that outputs the image under control of the processor and converts the image into an image of which the white balance is adjusted after a specified time elapses from the image output.

According to various embodiments, an electronic device may include at least one camera module including an image sensor, and a processor electrically connected to the camera module.

According to various embodiments, the processor may obtain an image corresponding to an external object by using the camera module, obtain a first signal corresponding to a first wavelength band and a second signal corresponding to a second wavelength band different from the first wavelength band by using image sensor, select at least one piece of optical information from specified optical information based on the first and second signals, and adjust a white balance of the image based on the selected at least one piece of optical information.

According to various embodiments, the image sensor may include a first filter having a response characteristic to an ultraviolet wavelength band as at least a portion of the first wavelength band, and a second filter having a response characteristic to an infrared wavelength band as at least a portion of the second wavelength band.

According to various embodiments, a method of processing an image based on external light in an electronic device may include obtaining the image corresponding to an external object, obtaining a first signal corresponding to a first wavelength band, obtaining a second signal corresponding to a second wavelength band different from the first wavelength band, selecting at least one piece of optical information from specified optical information based on the first and second signals, and adjusting a white balance of the image based on the selected at least one piece of optical information.

According to various embodiments, the obtaining of the first signal may include responding to an ultraviolet wavelength band as at least a portion of the first wavelength band.

According to various embodiments, the obtaining of the second signal may include responding to an infrared wavelength band as at least a portion of the second wavelength band.

According to various embodiments, the selecting of the at least one piece of optical information may include storing sunlight information of the first wavelength band and the second wavelength band corresponding to each of at least one condition associated with a first environment.

According to various embodiments, the selecting of the at least one piece of optical information may further include selecting first sunlight information corresponding to the first and second signal at a specified ratio or more from sunlight information of the first wavelength band and the second wavelength band corresponding to each of the at least one condition.

According to various embodiments, the selecting of the first sunlight information may include determining an operating environment of the electronic device as the first environment based on the first sunlight information.

According to various embodiments, the selecting of the first sunlight information may further include determining an ambient light source of the electronic device as sunlight based on the first sunlight information or the determining of the first environment.

According to various embodiments, the method may further include calculating a color temperature value corresponding to the selected at least one piece of optical information based on a ratio between a first value corresponding to the first signal and a second value corresponding to the second signal.

According to various embodiments, the adjusting of the white balance of the image may include using the calculated color temperature value for the white balance.

According to various embodiments, the calculating of the color temperature value may include storing the calculated color temperature value and the selected at least one piece of optical information while mapping the calculated color temperature value and the selected at least one piece of optical information.

According to various embodiments, the processing of the image based on the external light may further include outputting the image.

According to various embodiments, the outputting of the image may include converting the image into an image of which the white balance is adjusted after a specified time elapses from the image output.

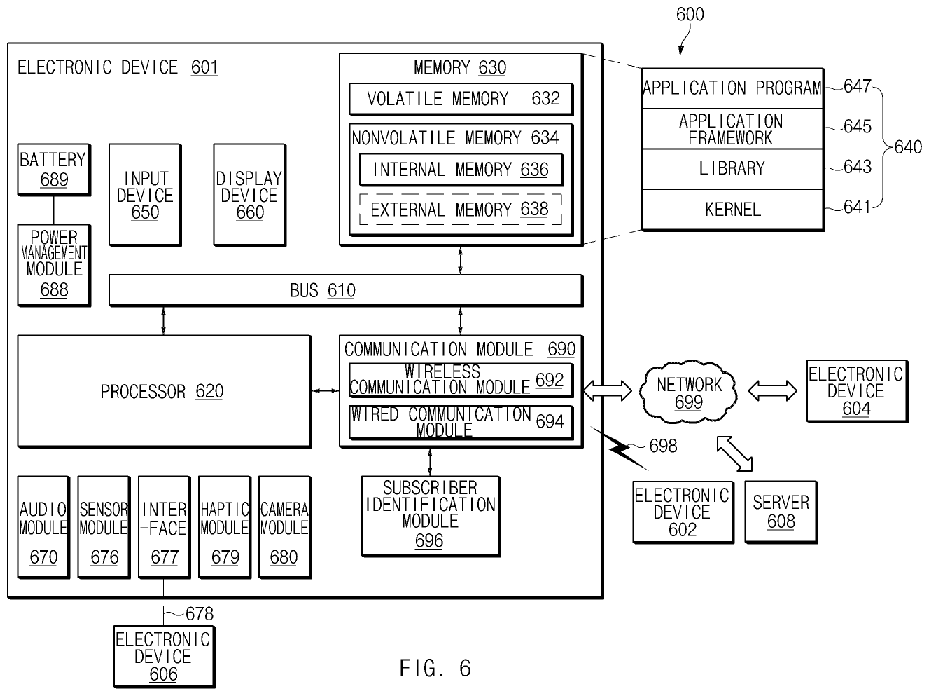

FIG. 6 illustrates an electronic device in a network environment, according to an embodiment.

Referring to FIG. 6, under a network environment 600, an electronic device 601 (e.g., the electronic device 100 of FIG. 2) may communicate with an electronic device 602 through short-range wireless communication 698 or may communication with an electronic device 604 or a server 608 through a network 699. According to an embodiment, the electronic device 601 may communicate with the electronic device 604 through the server 608.

According to an embodiment, the electronic device 601 may include a bus 610, a processor 620 (e.g., the processor 140 of FIG. 2), a memory 630, an input device 650 (e.g., a micro-phone or a mouse), a display device 660, an audio module 670, a sensor module 676, an interface 677, a haptic module 679, a camera module 680, a power management module 688, a battery 689, a communication module 690, and a subscriber identification module 696. According to an embodiment, the electronic device 601 may not include at least one (e.g., the display device 660 or the camera module 680) of the above-described components or may further include other component(s).

The bus 610 may interconnect the above-described components 620 to 690 and may include a circuit for conveying signals (e.g., a control message or data) between the above-described components. The processor 620 may include one or more of a central processing unit, an application processor, a graphic processing unit (GPU), an image signal processor (ISP) of a camera or a communication processor (CP). According to an embodiment, the processor 620 may be implemented with a system on chip (SoC) or a system in package (SiP). For example, the processor 620 may drive an operating system (OS) or an application program to control at least one of another component (e.g., hardware or software component) of the electronic device 601 connected to the processor 620 and may process and compute various data. The processor 620 may load a command or data, which is received from at least one of other components (e.g., the communication module 690), into a volatile memory 632 to process the command or data and may store the result data into a nonvolatile memory 634.

The memory 630 may include, for example, the volatile memory 632 or the nonvolatile memory 634. The volatile memory 632 may include, for example, a random access memory (RAM) (e.g., a dynamic RAM (DRAM), a static RAM (SRAM), or a synchronous DRAM (SDRAM)). The nonvolatile memory 634 may include, for example, an one time PROM (OTPROM), a programmable read-only memory (PROM), an erasable PROM (EPROM), an electrically EPROM (EEPROM), a mask ROM, a flash ROM, a flash memory, a hard disk drive, or a solid-state drive (SSD). In addition, the nonvolatile memory 634 may be configured in the form of an internal memory 636 or the form of an external memory 638 which is available through connection only if necessary, according to the connection with the electronic device 601. The external memory 638 may further include a flash drive such as compact flash (CF), secure digital (SD), micro secure digital (Micro-SD), mini secure digital (Mini-SD), extreme digital (xD), a multimedia card (MMC), or a memory stick. The external memory 638 may be operatively or physically connected with the electronic device 601 in a wired manner (e.g., a cable or a universal serial bus (USB)) or a wireless (e.g., Bluetooth) manner.

For example, the memory 630 may store, for example, at least one different software component, such as a command or data associated with the program 640, of the electronic device 601. The program 640 may include, for example, a kernel 641, a library 643, an application framework 645 or an application program (interchangeably, “application”) 647.

The input device 650 may include a microphone, a mouse, or a keyboard. According to an embodiment, the keyboard may include a keyboard physically connected or a virtual keyboard displayed through the display device 660.

The display device 660 may include a display, a hologram device or a projector, and a control circuit to control a relevant device. The display may include, for example, a liquid crystal display (LCD), a light emitting diode (LED) display, an organic LED (OLED) display, a microelectromechanical systems (MEMS) display, or an electronic paper display. According to an embodiment, the display may be flexibly, transparently, or wearably implemented. The display may include a touch circuitry, which is able to detect a user's input such as a gesture input, a proximity input, or a hovering input or a pressure sensor (interchangeably, a force sensor) which is able to measure the intensity of the pressure by the touch. The touch circuit or the pressure sensor may be implemented integrally with the display or may be implemented with at least one sensor separately from the display. The hologram device may show a stereoscopic image in a space using interference of light. The projector may project light onto a screen to display an image. The screen may be located inside or outside the electronic device 601.

The audio module 670 may convert, for example, from a sound into an electrical signal or from an electrical signal into the sound. According to an embodiment, the audio module 670 may acquire sound through the input device 650 (e.g., a microphone) or may output sound through an output device (not illustrated) (e.g., a speaker or a receiver) included in the electronic device 601, an external electronic device (e.g., the electronic device 602 (e.g., a wireless speaker or a wireless headphone)) or an electronic device 606 (e.g., a wired speaker or a wired headphone) connected with the electronic device 601.

The sensor module 676 may measure or detect, for example, an internal operating state (e.g., power or temperature) of the electronic device 601 or an external environment state (e.g., an altitude, a humidity, or brightness) to generate an electrical signal or a data value corresponding to the information of the measured state or the detected state. The sensor module 676 may include, for example, at least one of a gesture sensor, a gyro sensor, a barometric pressure sensor, a magnetic sensor, an acceleration sensor, a grip sensor, a proximity sensor, a color sensor (e.g., a red, green, blue (RGB) sensor), an infrared sensor, a biometric sensor (e.g., an iris sensor, a fingerprint sensor, a heartbeat rate monitoring (HRM) sensor, an e-nose sensor, an electromyography (EMG) sensor, an electroencephalogram (EEG) sensor, an electrocardiogram (ECG) sensor), a temperature sensor, a humidity sensor, an illuminance sensor, or an UV sensor. The sensor module 676 may further include a control circuit for controlling at least one or more sensors included therein. According to an embodiment, the sensor module 676 may be controlled by using a processor (e.g., a sensor hub) separate from the processor 620. In the case that the separate processor (e.g., a sensor hub) is used, while the processor 620 is in a sleep state, the separate processor may operate without awakening the processor 620 to control at least a portion of the operation or the state of the sensor module 676.

According to an embodiment, the interface 677 may include a high definition multimedia interface (HDMI), a universal serial bus (USB), an optical interface, a recommended standard 232 (RS-232), a D-subminiature (D-sub), a mobile high-definition link (MHL) interface, a SD card/MMC (multi-media card) interface, or an audio interface. A connector 678 may physically connect the electronic device 601 and the electronic device 606. According to an embodiment, the connector 678 may include, for example, an USB connector, an SD card/MMC connector, or an audio connector (e.g., a headphone connector).

The haptic module 679 may convert an electrical signal into mechanical stimulation (e.g., vibration or motion) or into electrical stimulation. For example, the haptic module 679 may apply tactile or kinesthetic stimulation to a user. The haptic module 679 may include, for example, a motor, a piezoelectric element, or an electric stimulator.

The camera module 680 may capture, for example, a still image and a moving picture. According to an embodiment, the camera module 680 may include at least one lens (e.g., a wide-angle lens and a telephoto lens, or a front lens and a rear lens), an image sensor, an image signal processor, or a flash (e.g., a light emitting diode or a xenon lamp).

The power management module 688, which is to manage the power of the electronic device 601, may constitute at least a portion of a power management integrated circuit (PMIC).

The battery 689 may include a primary cell, a secondary cell, or a fuel cell and may be recharged by an external power source to supply power at least one component of the electronic device 601.

The communication module 690 may establish a communication channel between the electronic device 601 and an external device (e.g., the first external electronic device 602, the second external electronic device 604, or the server 608). The communication module 690 may support wired communication or wireless communication through the established communication channel. According to an embodiment, the communication module 690 may include a wireless communication module 692 or a wired communication module 694. The communication module 690 may communicate with the external device (e.g., the first external electronic device 602, the second external electronic device 604, or the server 608) through a first network 698 (e.g. a short range communication network such as Bluetooth or infrared data association (IrDA)) or a second network 699 (e.g., a wireless wide area network such as a cellular network) through a relevant module among the wireless communication module 692 or the wired communication module 694.

The wireless communication module 692 may support, for example, cellular communication, short-range wireless communication, global navigation satellite system (GNSS) communication. The cellular communication may include, for example, long-term evolution (LTE), LTE Advance (LTE-A), code division multiple access (CDMA), wideband CDMA (WCDMA), universal mobile telecommunications system (UNITS), Wireless Broadband (WiBro), or Global System for Mobile Communications (GSM). The short-range wireless communication may include wireless fidelity (WiFi), WiFi Direct, light fidelity (LiFi), Bluetooth, Bluetooth low energy (BLE), Zigbee, near field communication (NFC), magnetic secure transmission (MST), radio frequency (RF), or a body area network (BAN). The GNSS may include at least one of a Global Positioning System (GPS), a Global Navigation Satellite System (Glonass), Beidou Navigation Satellite System (Beidou), the European global satellite-based navigation system (Galileo), or the like. In the disclosure, “GPS” and “GNSS” may be interchangeably used.

According to an embodiment, when the wireless communication module 692 supports cellar communication, the wireless communication module 692 may, for example, identify or authenticate the electronic device 601 within a communication network using the subscriber identification module (e.g., a SIM card) 696. According to an embodiment, the wireless communication module 692 may include a communication processor (CP) separate from the processor 620 (e.g., an application processor (AP)). In this case, the communication processor may perform at least a portion of functions associated with at least one of components 610 to 696 of the electronic device 601 in substitute for the processor 620 when the processor 620 is in an inactive (sleep) state, and together with the processor 620 when the processor 620 is in an active state. According to an embodiment, the wireless communication module 692 may include a plurality of communication modules, each supporting only a relevant communication scheme among cellular communication, short-range wireless communication, or a GNSS communication.

The wired communication module 694 may include, for example, a local area network (LAN) service, a power line communication, or a plain old telephone service (POTS).

For example, the first network 698 may employ, for example, WiFi direct or Bluetooth for transmitting or receiving commands or data through wireless direct connection between the electronic device 601 and the first external electronic device 602. The second network 699 may include a telecommunication network (e.g., a computer network such as a LAN or a WAN, the Internet or a telephone network) for transmitting or receiving commands or data between the electronic device 601 and the second electronic device 604.

According to various embodiments, the commands or the data may be transmitted or received between the electronic device 601 and the second external electronic device 604 through the server 608 connected with the second network 699. Each of the first and second external electronic devices 602 and 604 may be a device of which the type is different from or the same as that of the electronic device 601. According to various embodiments, all or a part of operations that the electronic device 601 will perform may be executed by another or a plurality of electronic devices (e.g., the electronic devices 602 and 604 or the server 608). According to an embodiment, in the case that the electronic device 601 executes any function or service automatically or in response to a request, the electronic device 601 may not perform the function or the service internally, but may alternatively or additionally transmit requests for at least a part of a function associated with the electronic device 601 to any other device (e.g., the electronic device 602 or 604 or the server 608). The other electronic device (e.g., the electronic device 602 or 604 or the server 608) may execute the requested function or additional function and may transmit the execution result to the electronic device 601. The electronic device 601 may provide the requested function or service using the received result or may additionally process the received result to provide the requested function or service. To this end, for example, cloud computing, distributed computing, or client-server computing may be used.

Various embodiments of the present disclosure and terms used herein are not intended to limit the technologies described in the present disclosure to specific embodiments, and it should be understood that the embodiments and the terms include modification, equivalent, and/or alternative on the corresponding embodiments described herein. With regard to description of drawings, similar components may be marked by similar reference numerals. The terms of a singular form may include plural forms unless otherwise specified. In the disclosure disclosed herein, the expressions “A or B”, “at least one of A and/or B”, “A, B, or C”, or “at least one of A, B, and/or C”, and the like used herein may include any and all combinations of one or more of the associated listed items. Expressions such as “first,” or “second,” and the like, may express their components regardless of their priority or importance and may be used to distinguish one component from another component but is not limited to these components. When an (e.g., first) component is referred to as being “(operatively or communicatively) coupled with/to” or “connected to” another (e.g., second) component, it may be directly coupled with/to or connected to the other component or an intervening component (e.g., a third component) may be present.

According to the situation, the expression “adapted to or configured to” used herein may be interchangeably used as, for example, the expression “suitable for”, “having the capacity to”, “changed to”, “made to”, “capable of” or “designed to” in hardware or software. The expression “a device configured to” may mean that the device is “capable of” operating together with another device or other parts. For example, a “processor configured to (or set to) perform A, B, and C” may mean a dedicated processor (e.g., an embedded processor) for performing corresponding operations or a generic-purpose processor (e.g., a central processing unit (CPU) or an application processor (AP)) which performs corresponding operations by executing one or more software programs which are stored in a memory device.

The term “module” used herein may include a unit, which is implemented with hardware, software, or firmware, and may be interchangeably used with the terms “logic”, “logical block”, “part”, “circuit”, or the like. The “module” may be a minimum unit of an integrated part or a part thereof or may be a minimum unit for performing one or more functions or a part thereof. The “module” may be implemented mechanically or electronically and may include, for example, an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor of FIG. 1a), may cause the processor to perform a function corresponding to the instruction. The computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), an embedded memory, and the like. The one or more instructions may contain a code made by a compiler or a code executable by an interpreter.

Each component (e.g., a module or a program module) according to various embodiments may be composed of single entity or a plurality of entities, a part of the above-described sub-components may be omitted, or other sub-components may be further included. Alternatively or additionally, after being integrated in one entity, some components (e.g., a module or a program module) may identically or similarly perform the function executed by each corresponding component before integration. According to various embodiments, operations executed by modules, program modules, or other components may be executed by a successive method, a parallel method, a repeated method, or a heuristic method, or at least one part of operations may be executed in different sequences or omitted. Alternatively, other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. An electronic device comprising:
a first optical sensor configured to have a response characteristic to a first wavelength band;
a second optical sensor configured to have a response characteristic to a second wavelength band different from the first wavelength band;
at least one camera module; and
a processor electrically connected to the first and second optical sensors and the camera module,
wherein the processor is configured to:
obtain an image corresponding to an external object by using the camera module,
obtain a first signal corresponding to the first wavelength band by using the first optical sensor,
obtain a second signal corresponding to the second wavelength band by using the second optical sensor,
select at least one piece of optical information from specified optical information based on the first and second signals, and
adjust a white balance of the image based on the selected at least one piece of optical information.

2. The electronic device of claim 1, wherein the first optical sensor is configured to respond to an ultraviolet wavelength band as at least a portion of the first wavelength band, and
wherein the second optical sensor is configured to respond to an infrared wavelength band as at least a portion of the second wavelength band.

3. The electronic device of claim 1, further comprising:
a memory configured to store sunlight information of the first wavelength band and the second wavelength band corresponding to each of at least one condition associated with a first environment, as at least a piece of the specified optical information.

4. The electronic device of claim 3, wherein the processor is configured to select first sunlight information when the first and second signals correspond to the first sunlight information of the first and second wavelength bands corresponding to a first condition stored in the memory at a specified ratio or more.

5. The electronic device of claim 4, wherein the processor is configured to determine an operating environment of the electronic device as the first environment based on the selected first sunlight information and determine an ambient light source of the electronic device as sunlight.

6. The electronic device of claim 3, wherein the processor is configured to calculate a color temperature value corresponding to the selected at least one piece of optical information based on a ratio between a first value corresponding to the first signal and a second value corresponding to the second signal, and use the calculated color temperature value to adjust the white balance of the image.

7. The electronic device of claim 1, further comprising:
a display configured to output the image under control of the processor and convert the image into an image of which the white balance is adjusted after a specified time elapses from the image output.

8. An electronic device comprising:
at least one camera module including an image sensor; and
a processor electrically connected to the camera module,
wherein the processor is configured to:
obtain an image corresponding to an external object by using the camera module,
obtain a first signal corresponding to a first wavelength band and a second signal corresponding to a second wavelength band different from the first wavelength band by using the image sensor,
select at least one piece of optical information from specified optical information based on the first and second signals, and
adjust a white balance of the image based on the selected at least one piece of optical information.

9. The electronic device of claim 8, wherein the image sensor includes:
a first filter having a response characteristic to an ultraviolet wavelength band as at least a portion of the first wavelength band, and
a second filter having a response characteristic to an infrared wavelength band as at least a portion of the second wavelength band.

10. A method of processing an image based on external light in an electronic device, the method comprising:
obtaining an image corresponding to an external object;
obtaining a first signal corresponding to a first wavelength band;
obtaining a second signal corresponding to a second wavelength band different from the first wavelength band;
selecting at least one piece of optical information from specified optical information based on the first and second signals; and
adjusting a white balance of the image based on the selected at least one piece of optical information.

11. The method of claim 10, wherein the obtaining of the first signal includes:
responding to an ultraviolet wavelength band as at least a portion of the first wavelength band, and
wherein the obtaining of the second signal includes:
responding to an infrared wavelength band as at least a portion of the second wavelength band.

12. The method of claim 10, wherein the selecting of the at least one piece of optical information includes:
storing sunlight information of the first wavelength band and the second wavelength band corresponding to each of at least one condition associated with a first environment.

13. The method of claim 12, wherein the selecting of the at least one piece of optical information further includes:
selecting first sunlight information corresponding to the first and second signals at a specified ratio or more from sunlight information of the first wavelength band and the second wavelength band corresponding to each of the at least one condition;
determining an operating environment of the electronic device as the first environment based on the first sunlight information; and
determining an ambient light source of the electronic device as sunlight based on the first sunlight information or the determining of the first environment.

14. The method of claim 10, further comprising:
calculating a color temperature value corresponding to the selected at least one piece of optical information based on a ratio between a first value corresponding to the first signal and a second value corresponding to the second signal,
wherein the adjusting of the white balance of the image includes:
using the calculated color temperature value for the white balance.

15. The method of claim 10, further comprising:
outputting the image,
wherein the outputting of the image includes:
converting the image into an image of which the white balance is adjusted after a specified time elapses from the image output.
